(19) United States
(12) Patent Application Publication
(10) Pub. No.: US 2005/0226385 A1
(43) Pub. Date: Oct. 13, 2005

(54) X-ray tube for a computed tomography system and method

(76) Inventors: James Edward Simpson, Niskayuna, NY (US); Hector Manuel Rodriguez, Rexford, NY (US); Mark Ernest Vermilyea, Niskayuna, NY (US); Maria Mercedes Otero, Albany, NY (US); Brian Douglas Lounsberry, Thiensville, WI (US)

Correspondence Address: Patrick S. Yoder;FLETCHER YODER, P.O. Box 692289, Houston, TX, 77269-2289, US

(21) Appl. No.: 10/813,365

(22) Filed: Mar. 30, 2004

(51) Int. Cl. H01J 35/24; H01J 35/10; H01J 35/26; H01J 35/28; H01J 35/04

(52) U.S. Cl. 378/132

(57) ABSTRACT

An X-ray tube is provided as a source of X-rays for imaging systems such as computed tomography (CT) system. The X-ray tube includes an anode assembly comprising a target for emitting X-rays upon irradiation with an electron beam, a rotor shaft coupled to the target and a motor rotor system such that the rotor shaft is configured to rotate the target, and at least two duplex bearing assemblies to support the rotor shaft. The X-ray tube further includes a cathode assembly comprising a cathode configured to emit electron beam and a conical insulator isolating the cathode from ground potential.

### BACKGROUND

The present invention relates generally to X-ray sources and, in particular, to X-ray tubes having a rotating anode assembly.

X-rays have found widespread application in various medical and non-medical imaging techniques. In general, X-ray based imaging systems direct an X-ray beam toward an object to be imaged. Typically, the X-ray beam is generated by an X-ray tube that consists of a cathode and a rotating disk anode maintained at a very high potential difference within a vacuum. Electrons are emitted from the cathode and are intercepted by the anode, which is typically coated with high atomic number material, causing the emission of X-rays along with waste heat. The emitted X-rays pass through the imaged object where they are absorbed or attenuated (weakened) based on the internal structure and composition of the object, creating a matrix or profile of X-ray beams of different strengths. This X-ray profile is registered on a film or detected digitally, thus creating an image.

For example, in computed tomography (CT) imaging, an X-ray tube and a detector may be mounted on a rotating frame called a gantry. As the CT gantry rotates around the patient, a fan or cone beam of X-rays passes through the patient body and the X-ray profile is created. The detector elements measure this X-ray profile and produce electronic data pulses proportional to the X-ray intensity they receive. The data pulses acquired at different positions on the CT gantry are processed by a computer to generate a digital image of the part of the patient through which the X-ray passed.

Current CT systems generally are limited in terms of how fast the gantry may rotate, thereby limiting the temporal resolution of the CT system. Limits on the temporal resolution of the CT system may inhibit the imaging of dynamic tissue, such as cardiac tissue. In addition, limits on the temporal resolution may result in lengthier scan times for large organs or regions of a patient. Such lengthy scan times may be inconvenient for the patient, especially children and those in emergency situations, as they have to hold their breath and stay motionless during the imaging process.

However improving temporal resolution by increasing the gantry rotation speed also increases the centrifugal stress on the X-ray tube. In particular, the load on the gantry may increase dramatically as a function of the weight of the X-ray tube and the rotational speed of the gantry. Thus, the size and weight of the X-ray tube may impose an effective limit on the rotational speed that may be attained by the gantry, thereby limiting the temporal resolution of the system.

It is therefore desirable to provide a compact X-ray tube that can withstand high structural loads, have excellent high-voltage stability and have increased axial coverage so as to enable fast CT scanning with high temporal resolution, thereby improving diagnosis and examination efficiency.

### BRIEF DESCRIPTION

In accordance with one aspect of the technique, an X-ray tube is provided for generating X-rays. The X-ray tube includes an anode assembly and a cathode assembly. The anode assembly includes a target for emitting X-rays upon irradiation with an electron beam, a rotor shaft coupled to a motor rotor system and the target such that the rotor shaft is configured to rotate the target, and at least two duplex bearing assemblies supporting the rotor shaft. The cathode assembly includes a cathode configured to emit an electron beam, and an insulator for isolating the cathode from ground potential.

In accordance with another aspect of the technique, a CT imaging system is provided. The imaging system includes a gantry adapted to rotate about a volume and an X-ray tube mounted on the gantry. The X-ray tube includes an anode assembly and a cathode assembly. The anode assembly includes a target for emitting X-rays upon irradiation with an electron beam, a rotor shaft coupled to a motor rotor system and the target such that the rotor shaft is configured to rotate the target, and at least two duplex bearing assemblies supporting the rotor shaft. The cathode assembly includes a cathode configured to emit an electron beam, and an insulator for isolating the cathode from ground potential. The imaging system also includes an X-ray detecting unit configured to detect the X-ray emitted from the X-ray tube and transmitted through the volume and to generate a detector output signal in response to the detected X-rays. The imaging system may also include an X-ray controller to operate the X-ray tube, a data acquisition system to receive the detector output signal and an image reconstructor coupled to the data acquisition system for generating an image signal in response to the detector output signal. A computer to control the operation of at least one of the X-ray controller, the data acquisition system and image reconstructor may also be present.

In accordance with a further aspect of the present technique, an anode assembly is provided. The anode assembly includes a target for emitting X-rays upon irradiation with an electron beam. The anode assembly may also include a rotor shaft coupled to a motor rotor system and the target, wherein the rotor shaft is configured to rotate the target. The anode assembly may also include a bearing system comprising at least two duplex bearing assemblies supporting the rotor shaft.

In accordance with an additional aspect of the present technique, a method is provided for CT imaging. The method provides for rotating a gantry about a subject at three rotations per second or faster. X-rays may be emitted from an X-ray tube mounted on the gantry. One or more images of the subject may be generated based upon the attenuation of the emitted X-rays by the subject. Systems and computer programs that afford functionality of the type defined by this method are also provided by the present technique.

### DRAWINGS

These and other features, aspects, and advantages of the present invention will become better understood when the following detailed description is read with reference to the accompanying drawings in which like characters represent like parts throughout the drawings, wherein:

FIG. 1 depicts an exemplary CT imaging system for volumetric imaging using an X-ray tube in accordance with one aspect of the present technique;

FIG. 2 depicts a perspective view of the X-ray tube in accordance with one aspect of present technique;

FIG. 3 depicts a sectional perspective view of an anode assembly of the X-ray tube of FIG. 2;

FIG. 4 depicts a sectional perspective view of a cathode assembly of the X-ray tube of FIG. 2;

FIG. 5 depicts a top view of a center frame assembly attached to the cathode assembly of FIG. 4; and

FIG. 6 depicts a sectional perspective view of the X-ray tube of FIG. 2.

### DETAILED DESCRIPTION

The present technique is generally directed to the generation of X-rays using an X-ray tube. Generally X-ray tubes may be used in variety of imaging systems, such as for medical imaging and baggage or package screening. Though the present discussion provides examples in a medical imaging context, one of ordinary skill in the art will readily comprehend that the application of these X-ray tubes in non-medical imaging contexts, such as for security screening, is well within the scope of the present technique.

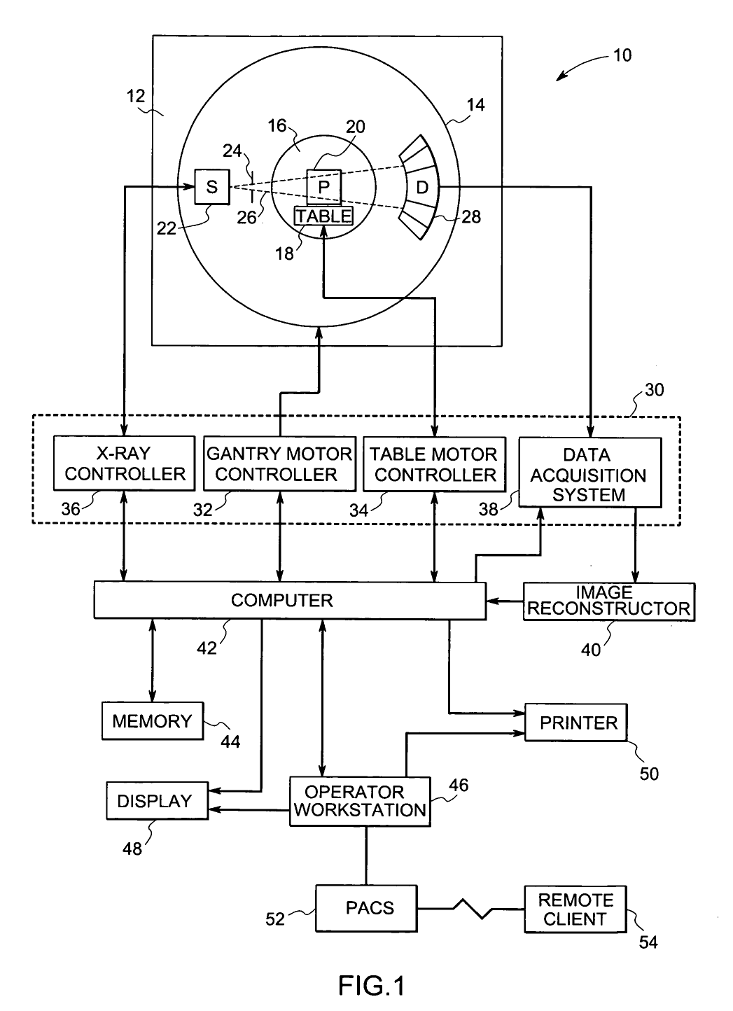

Referring now to FIG. 1, an imaging system 10 is illustrated for acquiring and processing image data. In the illustrated embodiment, the imaging system 10 is a computed tomography (CT) system designed both to acquire original image data and to process the image data for display and analysis. The CT imaging system 10 is illustrated with a frame 12 and a gantry 14 that has an aperture (imaging volume or CT bore volume) 16. A patient table 18 is positioned in the aperture 16 of the frame 12 and the gantry 14. The patient table 18 is adapted so that a patient 20 may recline comfortably during the examination process.

The gantry 14 includes an X-ray source 22 positioned adjacent to a collimator 24. The collimator 24 typically defines the size and shape of the X-ray beam 26 that emerges from the X-ray source 22. In this exemplary embodiment, the X-ray source 22 may be an X-ray tube in accordance with the present technique. In typical operation, the X-ray source 22 projects a stream of radiation (X-ray beam) 26 towards a detector array, represented generally at reference numeral 28, mounted on the opposite side of the gantry 14. All or part of the X-ray beam 26 passes through a subject, such as a human patient 20, prior to impacting the detector 28. It should be noted that all or part of the X-ray beam 26 may traverse a particular region of the patient 20, such as the liver, pancreas, heart, and so on, to allow a scan of the region to be acquired.

The detector array 28 may be a single slice detector or a multi-slice detector and is generally formed by a plurality of detector elements. Each detector element produces an electrical signal that represents the intensity of the incident X-ray beam 26 at the detector element when the X-ray beam 26 strikes the detector array 28. These signals are acquired and processed to reconstruct an image of the features within the subject 20.

Furthermore, the gantry 14 may be rotated around the subject 20 so that a plurality of radiographic views may be collected along an imaging trajectory described by the motion of the X-ray source 22 relative to the patient 20. In particular, as the X-ray source 22 and the detector array 28 rotate along with the CT gantry 14, the detector array 28 collects data of X-ray beam attenuation at the various view angles relative to the patient 20. Data collected from the detector array 28 then undergoes pre-processing and calibration to condition the data to represent the line integrals of the attenuation coefficients of the scanned objects 20. The processed data, commonly called projections, are then filtered and backprojected to formulate an image of the scanned area. Thus, an image or slice is acquired which may incorporate, in certain modes, less or more than 360 degrees of projection data, to formulate an image.

Rotation of the gantry 14 and operation of the source 22 is controlled by a system controller 30, which furnishes both power and control signals for CT examination sequences. Moreover, the detector array 28 is coupled to the system controller 30, which commands acquisition of the signals generated in the detector array 28. The system controller 30 may also execute various signal processing and filtration functions, such as for initial adjustment of dynamic ranges, interleaving of digital image data, and so forth. In general, system controller 30 commands operation of the imaging system 10 to execute examination protocols and to process acquired data. In the present context, system controller 30 also includes signal processing circuitry, typically based upon a general purpose or application-specific digital computer, associated memory circuitry for storing programs and routines executed by the computer, as well as configuration parameters and image data, interface circuits, and so forth.

In the embodiment illustrated in FIG. 1, system controller 30 is coupled to the CT gantry 14 and patient table 18. In particular, the system controller 30 includes a gantry motor controller 32 that controls the rotational speed and position of the gantry 14 and a table motor controller 34 that controls the linear displacement of the motorized table 18 within the CT bore volume 16. In this manner, the gantry motor controller 32 rotates the CT gantry 14, thereby rotating the X-ray source 22, collimator 24 and the detector array 28 one or multiple turns around the patient 20. Similarly, the table motor controller 34 displaces the patient table 18, and thus the patient 20, linearly within the CT bore volume 16. Additionally, the X-ray source 22 may be controlled by an X-ray controller 36 disposed within the system controller 30. Particularly, the X-ray controller 36 may be configured to provide power and timing signals to the X-ray source 22.

Further, the system controller 30 may include a data acquisition system 38. In this exemplary embodiment, the detector array 28 is coupled to the system controller 30, and more particularly to the data acquisition system 38. The data acquisition system 38 typically receives sampled analog signals from the detector array 28 and converts the data to digital signals for subsequent processing. An image reconstructor 40 coupled to the computer 42 may receive sampled and digitized data from the data acquisition system 38 and performs high-speed image reconstruction. Alternatively, reconstruction of the image may be done by the computer 42. Once reconstructed, the image produced by the imaging system 10 reveals internal features of the patient 20.

The computer 42 is typically coupled to the system controller 30. The data collected by the data acquisition system 38 or the reconstructed images may be transmitted to the computer 42 and moreover, to a memory 44. It should be understood that any type of memory to store a large amount of data may be utilized by such an exemplary imaging system 10. Also the computer 42 may be configured to receive commands and scanning parameters from an operator via an operator workstation 46 typically equipped with a keyboard and other input devices. An operator may control the imaging system 10 via the operator workstation 46. Thus, the operator may observe the reconstructed image and other data relevant to the system from computer 42, initiate imaging, and so forth.

A display 48 coupled to the operator workstation 46 and the computer 42 may be utilized to observe the reconstructed image and to control imaging. Additionally, the scanned image may also be printed on to a printer 50 which may be coupled to the computer 42 and the operator workstation 46. Further, the operator workstation 46 may also be coupled to a picture archiving and communications system (PACS) 52. It should be noted that PACS 52 may be coupled to a remote system 54, such as radiology department information system (RIS), hospital information system (HIS) or to an internal or external network, so that others at different locations may gain access to the image and to the image data.

It should be further noted that the computer 42 and operator workstation 46 may be coupled to other output devices which may include standard or special purpose computer monitors and associated processing circuitry. One or more operator workstations 46 may be further linked in the imaging system 10 for outputting system parameters, requesting examinations, viewing images, and so forth. In general, displays, printers, workstations, and similar devices supplied within the imaging system 10 may be local to the data acquisition components, or may be remote from these components, such as elsewhere within an institution or hospital, or in an entirely different location, linked to the imaging system 10 via one or more configurable networks, such as the Internet, virtual private networks, and so forth.

The exemplary imaging system 10, as well as other imaging systems based on X-ray attenuation, employs an X-ray source 22, such as an X-ray tube 56. For example, in accordance with aspects of the present technique, an exemplary X-ray tube 56 may consist of a cathode and a rotating anode disk. Electrons emitted from the cathode impact the rotating anode at a focal spot, generating X-rays. The rotating anode disk may be spun so that the focal spot traces a track around the anode disk, thereby reducing local temperatures in the disk and improving performance. The anode disk may rotate via a supporting bearing system consisting of two or more duplex bearing assemblies as well as a motor subsystem, which provides the motive torque. To provide a compact design, the motor subsystem and the cathode may be provided on the same side of the rotating anode disk. In addition, the X-ray tube may include an insulator subsystem, such as a conical insulator, to isolate the cathode from ground potential. As will be appreciated by one of ordinary skill in the art, the anode and cathode of the X-ray tube may be maintained in an evacuated jacket. Other X-ray tube components and subsystems may also be present to enhance performance.

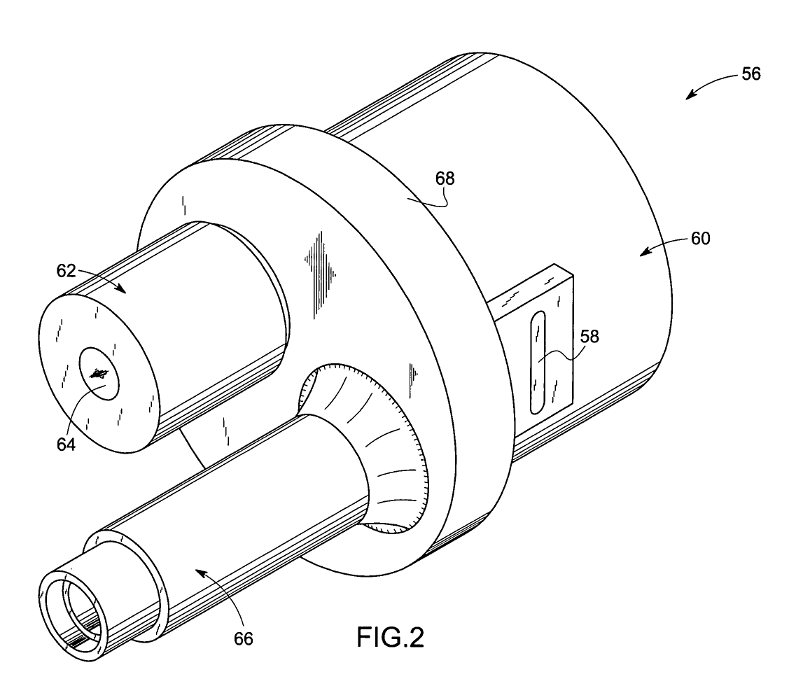

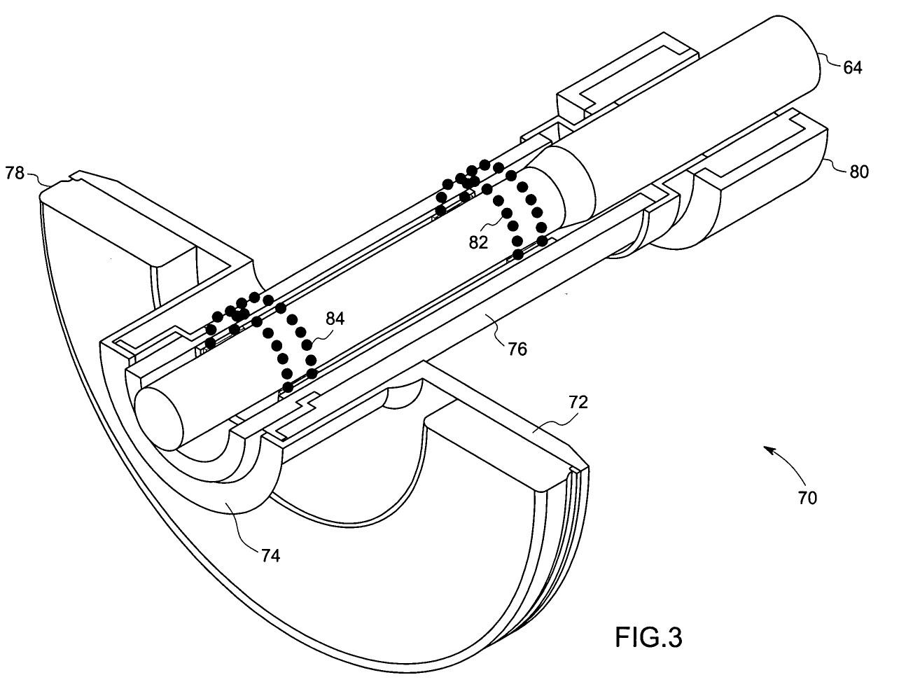

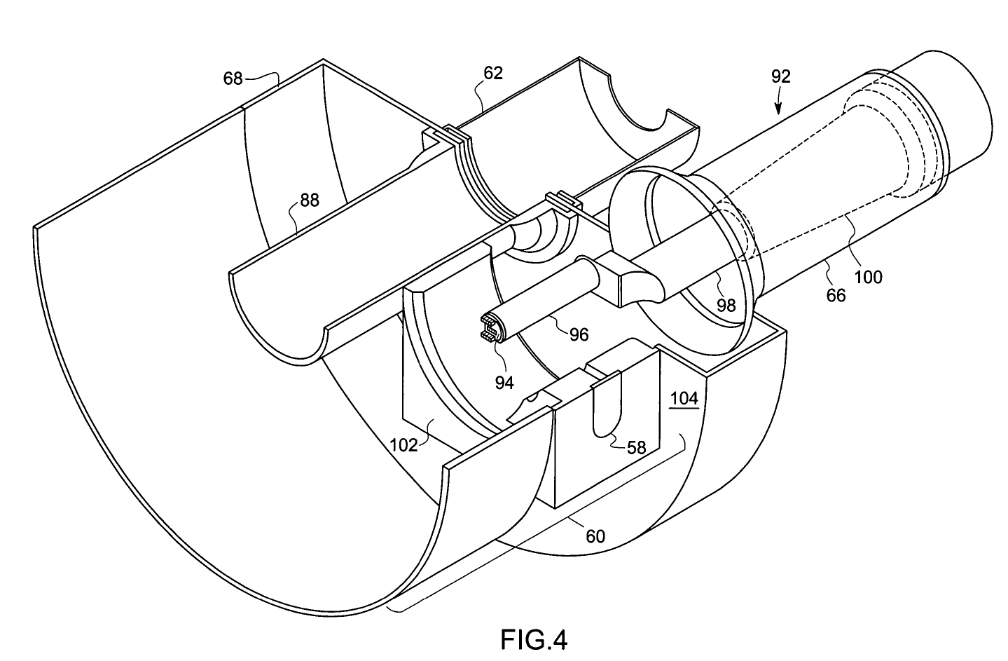

A perspective view of such an exemplary X-ray tube is provided in FIG.2. As depicted, the exemplary X-ray tube 56 may include an anode assembly and a cathode assembly disposed inside a vacuum jacket or frame. The anode assembly and the cathode assembly are explained in more detail with reference to FIG. 3 and FIG. 4 respectively herein below. Also shown in the FIG. 2 is an X-ray transparent window 58, disposed in the center frame assembly 60, through which generated X-rays may pass. In addition, the depicted X-ray tube 56 includes a rotor envelope 62 covering the rotor of the motor rotor system, a fixed stem 64 mechanically coupled to the rotor envelope 62 and an insulator shield 66 protecting the insulator coupled to the cathode frame 68.

Referring now to FIG. 3, a sectional view of an exemplary anode assembly 70 of the X-ray tube 56 is illustrated, according to one aspect of the present technique. The exemplary anode assembly 70 includes a target 72, in the shape of a disk, mechanically coupled to a target shaft 74, the target shaft 74 is in turn mechanically coupled to a rotor shaft 76. Alternatively, the rotor shaft 76 may extend to form the target shaft 74 and may be coupled to the target 72. Therefore, as the rotor shaft 76 rotates, the target 72 and target shaft 74, if present, also are rotated.

The target 72 may be fabricated from a material with high mechanical strength and creep resistance at elevated temperatures, such as high strength molybdenum alloys. Moreover, the target 72 may be coated with a material having high atomic number, high melting point, high thermal conductivity and/or high temperature strength, to facilitate X-ray emission. Generally the coating material is a high Z metal or a metal alloy with an atomic number greater than or equal to 40, such as, but not limited to, tungsten, tantalum, molybdenum, rhenium, rhodium, niobium, ruthenium, osmium, zirconium, tungsten-rhenium. A thermal mass 78 such as graphite or similar lightweight, high thermal capacitance material may be attached to the target disk 72 to improve heat storage.

A motor rotor system, such as an induction motor, provides motive torque to the rotor shaft 76 such that the rotor shaft 76 rotates the target 72 via the target shaft 74, as noted above. The motor includes a stator having the driving coils (not shown in the figure) and a rotor 80. The rotor shaft 76 may be coupled to the fixed stem 64 and, in one example, may be supported by two (or more) high capacity duplex bearing assemblies 82, 84 which straddle the target 72. Such a straddle configuration facilitates equal load sharing between the two duplex bearings assemblies 82, 84, thereby increasing the potential rotational speed of the gantry 14. For example, providing two duplex bearing assemblies 82, 84 at each end of the rotor shaft enables the bearings to withstand stress incurred at gantry speed of three rotations per second or faster for a given bearing size. In one implementation, the use of two straddle mounted duplex bearing assemblies 82, 84 allows a rotational velocity at approximately five rotations per second (i.e., a rotation every 0.2 seconds) to be obtained. Alternatively, duplex bearing assemblies may be arranged in either a tandem, back-to-back or face-to-face configuration so that the load on the rotating bearings is shared by two rows of bearings at each end of the rotor shaft 76.

While FIG. 3, depicts the anode assembly 70, FIG. 4 illustrates a sectional perspective view of a cathode assembly 92 coupled to a cathode frame 68, which, in turn, is coupled to a center frame assembly 60. In one implementation, the anode assembly 70 is placed inside the receptor 88 brazed to the cathode frame 68 and aligned such that, the rotor 80 fits inside the rotor envelope 62, which in turn is welded to the cathode frame 68. The fixed stem 64 may then be then welded to the rotor envelope 62. In such an implementation, the rotor 80 and the cathode assembly 92 are both located on the same side of the cathode frame 68, thereby providing a compact configuration.

The cathode assembly 92 is typically coupled to the cathode frame 68 and includes a cathode 94 mechanically supported and spatially positioned by a cathode support 96. The cathode support 96 is connected to a cathode arm 98 which may be insulated, such as by the depicted conical insulator 100 or other high voltage insulator. High voltage leads that provide electrical power to the cathode 94 may be insulated by the cathode support 96 and by the conical insulator 100. An insulator shield 66 may be provided to cover the conical insulator 100 or other insulator. As discussed above, in one implementation, the axis of the insulator may be co-directional and radially offset, i.e., generally parallel, relative to the rotor 80. Such an implementation provides a compact configuration for the X-ray tube 56.

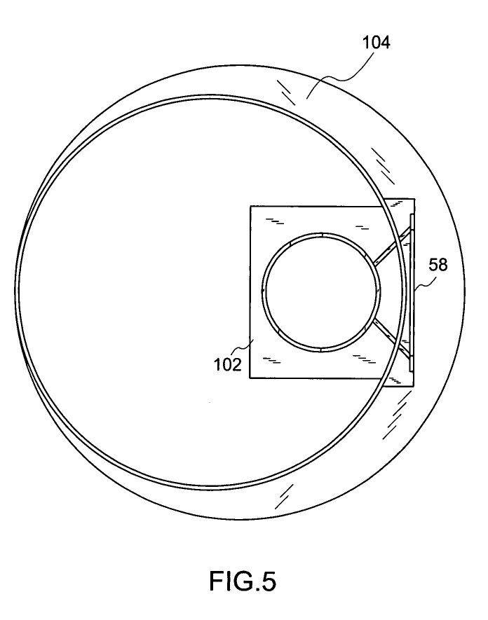

The center frame assembly 60 further includes an electron collector 102 that confines the emitted electron beam. An X-ray transparent window 58 on an outside face of the electron collector 102 is fabricated to be suitably low in attenuation of X-ray 26 and is typically made of beryllium. In one implementation, the X-ray transparent window 58 may be displaced about 60 mm from the focal spot, i.e., the region where the electron beam strikes the rotating target 72. The center frame assembly 60 is coupled to the cathode frame 68 via an overhang 104 of varying width. In one implementation the overhang 104 is welded to the cathode frame 68 such that the side of the overhang 104 towards the electron collector 102 is welded to the side of the cathode frame 68 wherein the cathode assembly 92 is disposed. FIG. 5 illustrates a top view of the center frame assembly 60 of an implementation having an overhang 104 of varying width in relation to the electron collector 102.

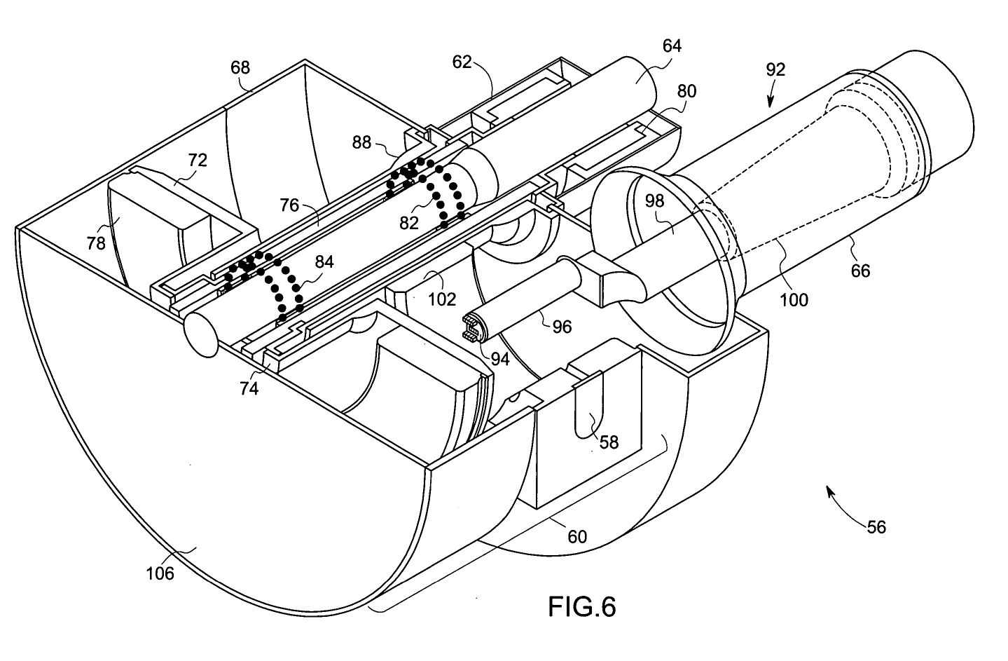

The various exemplary components discussed in FIG. 3-5 may be assembled to form an exemplary X-ray tube 56 as depicted in FIG. 6. As depicted in FIG. 6, the anode assembly 70 may be placed inside the receptor 88 coupled to the cathode frame 68. The electron collector 102 disposed within the center frame assembly 60 confines the electrons emitted by the cathode 94, which then strike the rotating target 72 at a generally perpendicular angle. The target 72 emits X-rays when impacted by the electrons. The emitted X-rays exit the X-ray tube 56 via the X-ray transparent window 56 to provide a stream of radiation 26 useful in imaging techniques. In one implementation, an anode cap 106 is fitted at the top of the anode assembly to cover the center frame 60. High-voltage subsystems may be separated from ground potential subsystems by a reasonable standoff, imparting high voltage stability to the X-ray tube 56. Furthermore, the X-ray tube may be disposed inside an evacuated chamber, which maintains internal vacuum and rejects the waste heat via an external coolant flow.

The X-ray tube 56 described herein may be used in fast CT scanning, such as with a gantry rotation speed of three rotations per second or better. Indeed, in one implementation five rotations per second (i.e., a rotation every 0.2 seconds) may be achieved. In addition, the X-ray tube 56 described herein may provide high-voltage stability of up to 200 kV in operation and axial coverage of up to 80 mm from the focal spot. In addition, these benefits may be obtained with a compact configuration of the X-ray tube 56 having reduced size and weight relative to other configurations. Furthermore, the compact design and the use of dual duplex bearing assemblies 82, 84 which straddle the target allow to the X-ray tube 56 to withstand the high structural stresses of up to 65 g which may be associated with faster gantry rotational speeds. The X-ray tubes 56, therefore, may be used to enable faster gantry rotations of the CT imaging system 10, thereby increasing temporal resolution and improving diagnostic capability.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An X-ray tube, comprising:
an anode assembly, comprising:
a target for emitting X-rays upon irradiation with an electron beam,
a rotor shaft coupled to a motor rotor system and the target, the rotor shaft configured to rotate the target, and
a bearing system comprising at least two duplex bearing assemblies supporting the rotor shaft; and
a cathode assembly, comprising:
a cathode configured to emit the electron beam, and
an insulator isolating the cathode from ground potential, wherein the insulator and the motor rotor system are located on the same side of the target.

2. The X-ray tube of claim 1, wherein the insulator comprises a conical insulator.

3. (canceled)

4. The X-ray tube of claim 1, wherein the insulator is offset in a radial direction to the motor rotor system.

5. The X-ray tube of claim 1, wherein the at least two duplex bearing assemblies distribute load substantially evenly.

6. The X-ray tube of claim 1, wherein the at least two duplex bearing assemblies straddle the target.

7. A CT system, comprising:
a gantry adapted to rotate about a volume;
an X-ray tube mounted on the gantry, the X-ray tube, comprising:
an anode assembly, comprising:
a target for emitting X-rays upon irradiation with an electron beam,
a rotor shaft coupled to a motor rotor system and the target, the rotor shaft configured to rotate the target, and
a bearing system comprising at least two duplex bearing assemblies supporting the rotor shaft; and
a cathode assembly, comprising:
a cathode configured to emit the electron beam, and
an insulator isolating the cathode from ground potential, wherein the insulator and the motor rotor system are located on the same side of the target;
an X-ray detecting unit configured to detect the X-rays emitted from the X-ray tube and transmitted through the volume and to generate a detector output signal in response to the detected X-rays;
an X-ray controller configured to operate the X-ray tube;
a data acquisition system for receiving the detector output signal;
an image reconstructor coupled to the data acquisition system for generating an image signal in response to the detector output signal; and
a computer for controlling the operation of at least one of the X-ray controller, the data acquisition system and the image reconstructor.

8. The CT system of claim 7, wherein the insulator comprises a conical insulator.

9. (canceled)

10. The CT system of claim 7, wherein the insulator is offset in a radial direction to the motor rotor system.

11. The CT system of claim 7, further comprising a collimator to direct the beam to the subject.

12. The CT system of claim 7, wherein the at least two duplex bearing assemblies distribute load substantially evenly.

13. The CT system of claim 7, wherein the at least two duplex bearing assemblies straddle the target.

14. An anode assembly, comprising:
a target for emitting X-rays upon irradiation with an electron beam;
a rotor shaft coupled to a motor rotor system and the target, the rotor shaft configured to rotate the target; and
a bearing system comprising at least two duplex bearing assemblies supporting the rotor shaft, wherein the at least two duplex bearing assemblies straddle the target.

15. The anode assembly of claim 14, further comprising a fixed stem.

16. The anode assembly of claim 15, wherein the rotor shaft is coupled with the fixed stem via the at least two duplex bearing assemblies.

17. The anode assembly of claim 14, wherein the at least two duplex bearing assemblies allows load to be distributed substantially evenly.

18. (canceled)

19. A method for CT imaging, the method comprising:
rotating a gantry about a subject at greater than three rotations per second;
emitting X-rays from an X-ray tube mounted on the gantry; and
generating one or more images of the subject based upon the attenuation of the emitted X-rays by the subject.

20. The method of claim 19, wherein rotating the gantry comprises rotating the gantry at approximately five rotations per second.

21. A CT system, comprising:
means for rotating a gantry about a subject at greater than three rotations per second;
means for emitting X-rays from an X-ray tube mounted on the gantry; and
means for generating one or more images of the subject based upon the attenuation of the emitted X-rays by the subject.
